(19) United States
(12) Patent Application Publication
(10) Pub. No.: US 2020/0361000 A1
(43) Pub. Date: Nov. 19, 2020

(54) A POLYCRYSTALLINE SUPER HARD CONSTRUCTION AND A METHOD OF MAKING SAME

(71) Applicant: ELEMENT SIX (UK) LIMITED, Oxfordshire (GB)

(72) Inventor: Mandar Rajiv Thakare, Oxfordshire (GB)

(21) Appl. No.: 16/766,085

(22) PCT Filed: Dec. 21, 2018
(86) PCT No.: PCT/EP2018/086615

§ 371 Date: May 21, 2020

(30) Foreign Application Priority Data
Dec. 31, 2017 (GB) 1722324.9

(51) Int. Cl. B22F 7/08; E21B 10/567; B22F 3/14; B22F 5/00; B22F 3/24; C22C 26/00; C04B 35/528; C04B 35/645

(52) U.S. Cl. CPC B22F 7/08; E21B 10/567; B22F 3/14; B22F 5/00; B22F 3/24; C22C 26/00; C04B 2235/612; C04B 35/645; B22F 2005/001; B22F 2302/406; B22F 2301/15; C04B 2235/427; C04B 2235/425; C04B 35/528

(57) ABSTRACT

A polycrystalline super hard construction has a body of polycrystalline diamond material with a working surface, a first region substantially free of a solvent/catalysing material extending a depth from the working surface into the body of PCD material, and a second region remote from the working surface that includes solvent/catalysing material. The first and second regions are joined along a boundary. A chamfer extends between the working surface and a peripheral side surface of the body of PCD material. The distance from the midpoint of the chamfer to the boundary of the first and second regions along a plane substantially perpendicular to the plane in which the chamfer extends is at least X divided by two, where X is 0.8 times the thickness of the body of PCD material.

### FIELD

This disclosure relates to a polycrystalline super hard construction comprising a body of polycrystalline diamond (PCD) material and a method of making a thermally stable polycrystalline diamond construction

### BACKGROUND

Cutter inserts for machining and other tools may comprise a layer of polycrystalline diamond (PCD) bonded to a cemented carbide substrate. PCD is an example of a super hard material, also called super abrasive material.

Components comprising PCD material are used in a wide variety of tools for cutting, machining, drilling or degrading hard or abrasive materials such as rock, metal, ceramics, composites and wood-containing materials. PCD material comprises a mass of substantially inter-grown diamond grains forming a skeletal mass which defines interstices between the diamond grains and PCD material typically comprises at least about 80 volume % of diamond and may be made by subjecting an aggregated mass of diamond grains to an ultra-high pressure of greater than about 5 GPa, typically about 5.5 GPa, and temperature of at least about 1200° C., usually about 1440° C., in the presence of a sintering aid, also referred to as a catalyst material for diamond. Catalyst materials for diamond are understood to be materials that are capable of promoting direct inter-growth of diamond grains at a pressure and temperature condition at which diamond is thermodynamically more stable than graphite.

Catalyst materials for diamond typically include any Group VIII element and common examples are cobalt, iron, nickel and certain alloys including alloys of any of these elements. PCD material may be formed on a cobalt-cemented tungsten carbide substrate, which may provide a source of cobalt catalyst material for the PCD. During sintering of the body of PCD material, a constituent of the cemented-carbide substrate, such as cobalt in the case of a cobalt-cemented tungsten carbide substrate, liquefies and sweeps from a region adjacent the volume of diamond particles into interstitial regions between the diamond particles. In this example, the cobalt acts as a catalyst to facilitate the formation of inter-bonded diamond grains. Optionally, a metal-solvent catalyst may be mixed with diamond particles prior to subjecting the diamond particles and substrate to the HPHT process. The interstices within PCD material may at least partly be filled with the catalyst material. The intergrown diamond structure therefore comprises original diamond grains as well as a newly precipitated or re-grown diamond phase, which bridges the original grains. In the final sintered structure, catalyst/solvent material generally remains present within at least some of the interstices that exist between the sintered diamond grains.

A problem known to exist with such conventional PCD compacts is that they are vulnerable to thermal degradation when exposed to elevated temperatures during cutting and/or wear applications. It is believed that this is due, at least in part, to the presence of residual solvent/catalyst material in the microstructural interstices which, due to the differential that exists between the thermal expansion characteristics of the interstitial solvent metal catalyst material and the thermal expansion characteristics of the intercrystalline bonded diamond, is thought to have a detrimental effect on the performance of the PCD cutting element at high temperatures. Such differential thermal expansion is known to occur at temperatures of about 400[deg.] C., and is believed to cause ruptures to occur in the diamond-to-diamond bonding, and eventually result in the formation of cracks and chips in the PCD structure. The chipping or cracking in the PCD structure may degrade the mechanical properties of the cutting element or lead to failure of the cutting element during drilling or cutting operations thereby rendering the PCD structure unsuitable for further use.

Another form of thermal degradation known to exist with conventional PCD materials is one that is also believed to be related to the presence of the solvent metal catalyst in the interstitial regions and the adherence of the solvent metal catalyst to the diamond crystals. Specifically, at high temperatures, diamond grains may undergo a chemical breakdown or back-conversion with the solvent/catalyst. At extremely high temperatures, the solvent metal catalyst is believed to cause an undesired catalyzed phase transformation in diamond such that portions of diamond grains may transform to carbon monoxide, carbon dioxide, graphite, or combinations thereof, thereby degrading the mechanical properties of the PCD material and limiting practical use of the PCD material to about 750[deg.] C.

Attempts at addressing such unwanted forms of thermal degradation in conventional PCD materials are known in the art. Generally, these attempts have focused on the formation of a PCD body having an improved degree of thermal stability when compared to the conventional PCD materials discussed above. One known technique of producing a PCD body having improved thermal stability involves, after forming the PCD body, removing all or a portion of the solvent catalyst material therefrom using, for example, chemical leaching. Removal of the catalyst/binder from the diamond lattice structure renders the polycrystalline diamond layer more heat resistant.

Due to the hostile environment that cutting elements typically operate, cutting elements having cutting layers with improved abrasion resistance, strength and fracture toughness are desired. However, as PCD material is made more wear resistant, for example by removal of the residual catalyst material from interstices in the diamond matrix, it typically becomes more brittle and prone to fracture and therefore tends to have compromised or reduced resistance to spalling.

There is therefore a need to overcome or substantially ameliorate the above-mentioned problems to provide a PCD material having increased resistance to spalling and chipping.

### SUMMARY

Viewed from a first aspect there is provided a polycrystalline super hard construction comprising a body of polycrystalline diamond (PCD) material comprising a plurality of interstitial regions between inter-bonded diamond grains forming the polycrystalline diamond material; the body of PCD material comprising:
a working surface positioned along an outside portion of the body;
a first region substantially free of a solvent/catalysing material; the first region extending a depth from the working surface into the body of PCD material along a plane substantially perpendicular to the plane along which the working surface extends; and
a second region remote from the working surface that includes solvent/catalysing material in a plurality of the interstitial regions; the first region joining the second region along a boundary therebetween;
a substrate attached to the body of PCD material along an interface with the second region;
a chamfer extending between the working surface and a peripheral side surface of the body of PCD material and defining a cutting edge at the intersection of the chamfer and the peripheral side surface; the body of PCD material having a thickness along the peripheral side surface from the working surface to the substrate; wherein:
the distance from the midpoint of the chamfer to the boundary of the first and second regions along a plane substantially perpendicular to the plane in which the chamfer extends is at least X divided by two, where X is 0.8 times the thickness of the body of PCD material.

Viewed from a second aspect there is provided a method for making a thermally stable polycrystalline diamond (PCD) construction comprising the steps of:

machining a polycrystalline diamond (PCD) body attached to a substrate along an interface, the polycrystalline diamond body comprising a plurality of interbonded diamond grains and interstitial regions disposed therebetween, to form a chamfer extending between a working surface positioned along an outside portion of the body and a peripheral side surface of the body;
treating the PCD body to remove a solvent/catalyst material from a first region of the diamond body while allowing the solvent/catalyst material to remain in a second region of the diamond body;

the chamfer defining a cutting edge at the intersection of the chamfer and the peripheral side surface; wherein:

the step of treating further comprises masking the PCD body at a position between 0 microns to around 300 microns from the working surface; and

the step of removing solvent/catalyst from the interstitial regions in the first region comprises removing the solvent/catalyst such that the distance from the midpoint of the chamfer to the boundary of the first and second regions along a plane substantially perpendicular to the plane in which the chamfer extends is at least X divided by two, where X is 0.8 times the thickness of the body of PCD material.

### BRIEF DESCRIPTION OF THE DRAWINGS

Various examples will now be described in more detail, by way of example only, and with reference to the accompanying figures in which:

FIG. 1 is a schematic cross-sectional drawing of half of an example PCD construction comprising an example PCD structure bonded to a substrate;

FIG. 2 is a schematic drawing of the microstructure of a conventional body of PCD material; and

FIG. 3 is a schematic cross-section through a portion of an example PCD construction.

### DETAILED DESCRIPTION

The same references refer to the same general features in all the drawings.

### Description

As used herein, a “super hard material” is a material having a Vickers hardness of at least about 28 GPa. Diamond and cubic boron nitride (cBN) material are examples of super hard materials.

As used herein, a “super hard construction” means a construction comprising a body of polycrystalline super hard material. In such a construction, a substrate may be attached thereto or alternatively the body of polycrystalline material may be free-standing and unbacked.

As used herein, polycrystalline diamond (PCD) is a type of polycrystalline super hard (PCS) material comprising a mass of diamond grains, a substantial portion of which are directly inter-bonded with each other and in which the content of diamond is at least about 80 volume percent of the material. As used herein, “interstices” or “interstitial regions” are regions between the diamond grains of PCD material. In some examples of PCD material, interstices between the diamond grains may be at least partly filled with a binder material comprising a catalyst for diamond. In some examples of PCD material, interstices or interstitial regions may be substantially or partially filled with a material other than diamond, or they may be substantially empty. PCD material may comprise at least a region from which catalyst material has been removed from the interstices, leaving interstitial voids between the diamond grains.

A “catalyst material” for a super hard material is capable of promoting the growth or sintering of the super hard material.

The term “substrate” as used herein means any substrate over which the super hard material layer is formed. For example, a “substrate” as used herein may be a transition layer formed over another substrate.

As used herein, the term “integrally formed” regions or parts are produced contiguous with each other and are not separated by a different kind of material.

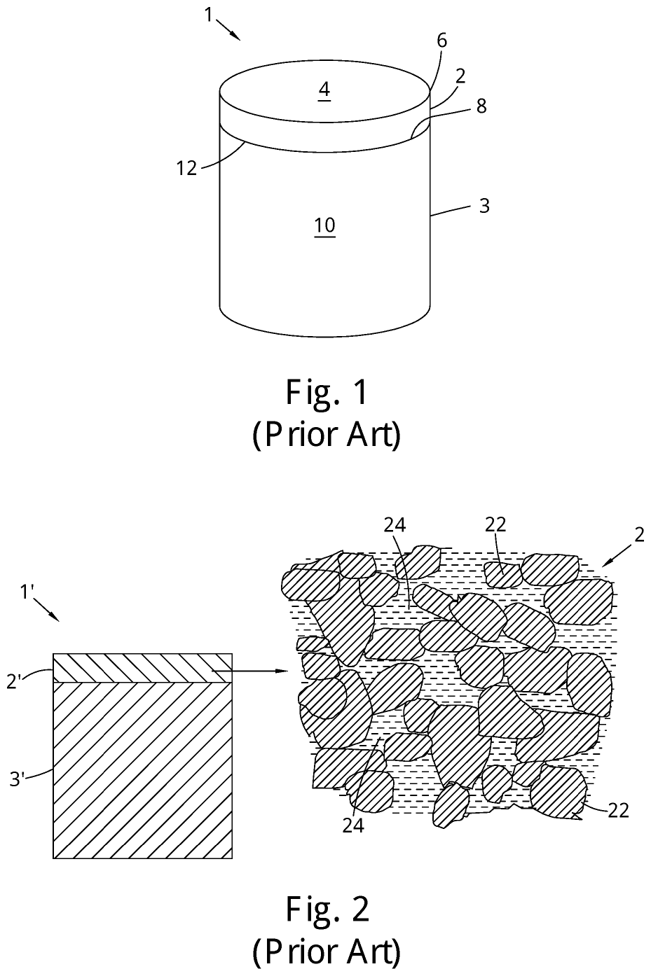

An example of a super hard construction is shown in FIG. 1 and includes a cutting element 1 having a layer of super hard material 2 formed on a substrate 3. The substrate 3 may be formed of a hard material such as cemented tungsten carbide. The super hard material 2 may be, for example, polycrystalline diamond (PCD), or a thermally stable product such as thermally stable PCD (TSP). The cutting element 1 may be mounted into a bit body such as a drag bit body (not shown) and may be suitable, for example, for use as a cutter insert for a drill bit for boring into the earth.

The exposed top surface of the super hard material opposite the substrate forms the cutting face 4, also known as the working surface, which is the surface which, along with its edge 6, performs the cutting in use.

At one end of the substrate 3 is an interface surface 8 that forms an interface with the super hard material layer 2 which is attached thereto at this interface surface. As shown in the example of FIG. 1, the substrate 3 may be generally cylindrical and has a peripheral surface 14 and a peripheral top edge 16.

The super hard material may be, for example, polycrystalline diamond (PCD) and the super hard particles or grains may be of natural and/or synthetic origin.

The substrate 3 may be formed of a hard material such as a cemented carbide material and may be, for example, cemented tungsten carbide, cemented tantalum carbide, cemented titanium carbide, cemented molybdenum carbide or mixtures thereof. The binder metal for such carbides suitable for forming the substrate 3 may be, for example, nickel, cobalt, iron or an alloy containing one or more of these metals. Typically, this binder will be present in an amount of 10 to 20 mass %, but this may be as low as 6 mass % or less. Some of the binder metal may infiltrate the body of polycrystalline super hard material 2 during formation of the compact 1.

As shown in FIG. 2, during formation of a conventional polycrystalline composite construction, the diamond grains are directly interbonded to adjacent grains and the interstices 24 between the grains 22 of super hard material such as diamond grains in the case of PCD, may be at least partly filled with a non-super hard phase material. This non-super hard phase material, also known as a filler material, may comprise residual catalyst/binder material, for example cobalt, nickel or iron. The typical average grain size of the diamond grains 22 is larger than 1 micron and the grain boundaries between adjacent grains is therefore typically between micron-sized diamond grains, as shown in FIG. 2.

The working surface or “rake face” 4 of the polycrystalline composite construction 1 is the surface or surfaces over which the chips of material being cut flow when the cutter is used to cut material from a body, the rake face 4 directing the flow of newly formed chips. This face 4 is commonly also referred to as the top face or working surface of the cutting element as the working surface 4 is the surface which, along with its edge 6, is intended to perform the cutting of a body in use. It is understood that the term “cutting edge”, as used herein, refers to the actual cutting edge, defined functionally as above, at any particular stage or at more than one stage of the cutter wear progression up to failure of the cutter, including but not limited to the cutter in a substantially unworn or unused state.

As used herein, “chips” are the pieces of a body removed from the work surface of the body being cut by the polycrystalline composite construction 1 in use.

As used herein, a “wear scar” is a surface of a cutter formed in use by the removal of a volume of cutter material due to wear of the cutter. A flank face may comprise a wear scar. As a cutter wears in use, material may progressively be removed from proximate the cutting edge, thereby continually redefining the position and shape of the cutting edge, rake face and flank as the wear scar forms.

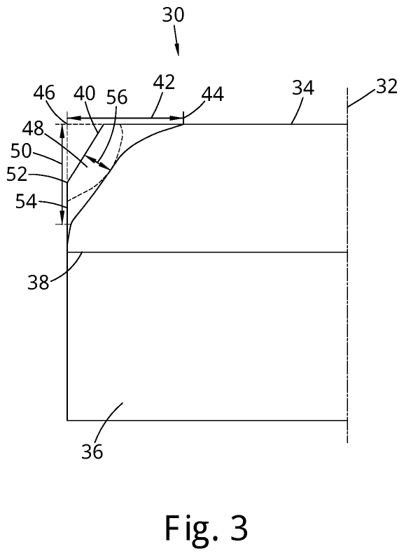

With reference to FIG. 3, an example polycrystalline super hard construction comprises a cutting element 30 having a layer of super hard material 34 formed on a substrate 36. The substrate 36 may be formed of a hard material such as cemented tungsten carbide. The super hard material 34 may be, for example, polycrystalline diamond (PCD. The cutting element 30 is substantially cylindrical and has a longitudinal axis 32 extending therethrough.

The exposed top surface of the super hard material opposite the substrate forms the cutting face, also known as the working surface, which is the surface which, along with its edge 52, performs the cutting in use.

At one end of the substrate 36 is an interface surface 38 that forms an interface with the super hard material layer 34 which is attached thereto at this interface surface. A chamfer 40 is formed in the structure adjacent the cutting edge 52 and flank or barrel surface 54. The rake face is therefore joined to the flank 54 by the chamfer 40 which extends from the cutting edge 52 to the rake face, and lies in a plane at a predetermined angle to the plane perpendicular to the plane in which the longitudinal axis of the cutter extends. In some examples, this chamfer angle may be up to around 45 degrees. The vertical height of the chamfer 40 may be, for example, between around 200 μm and around 300 μm, or, for example, between around 350 μm to around 450 μm, such as around 400 μm.

FIG. 3 is a schematic representation of an example PCD construction 30 which has been treated to remove residual solvent/catalyst from interstitial spaces between the diamond grains using the techniques described in detail below. The chamfer 40 may, for example, be formed prior to creating the leaching profile shown in FIG. 3. The region from which residual solvent/catalyst has been removed is denoted by reference numeral 48 in FIG. 3.

As used herein, the thickness of the body of super hard material 34 or the substrate 36 is the thickness measured substantially perpendicularly to the working surface 34 from the top of the working surface along the barrel or flank of the construction to the point of intersection at the barrel with the substrate at the interface 38. In some examples, the superhard material is a body of PCD material 34 which may have a thickness of at least about 2.5 to at least 4.5 mm. In one example, the superhard material is a body of PCD material 34 which may have a thickness in the range from about 2 mm to about 3.5 mm.

In the examples, the distance from the midpoint of the chamfer 40 to the leached/unleached boundary along a plane substantially perpendicular to the plane in which the chamfer lies is denoted by reference numeral 56. The applicants have determined that this distance 56 should be at least X divided by two, where X is 0.8 times the thickness of the diamond table. In some examples, the distance “0.8 X” which is denoted by the reference numeral 42 in FIG. 3 may correspond to the radial distance along the working surface 34 from the notional edge of the construction (had the construction remained cylindrical without application of the chamfer) to the point on the working surface denoting the leached region/unleached boundary.

In some examples, this distance 42 is substantially equal to the distance along the barrel 54 from the (unchamfered) edge 46 of the construction to the point on the barrel surface 54 denoting the leached region/unleached boundary. Additionally, the applicants have found it may be advantageous in some examples, for the leach depth at a radial distance of 1 mm from the notional peripheral side edge 46 of the working face of the construction (had the chamfer not been applied to the construction) to be at least 600 microns, and in some examples at least 700 microns. In other words, the depth from the working surface of the boundary between the first and second regions at a radial distance of 1 mm from the cutting edge 52 is at least 600 microns and in some examples at least 700 microns.

It has been appreciated by the applicant that, surprisingly, the above may assist in controlling spalling events during use of the PCD construction in applications by assisting in managing the thermal wear events of the construction thereby potentially delaying the onset of spalling and prolonging the working life of the construction 30.

The cutter of FIG. 3 may be fabricated, for example, as follows.

As used herein, a “green body” is a body comprising grains to be sintered and a means of holding the grains together, such as a binder, for example an organic binder.

Examples of super hard constructions 30 may be made by a method of preparing a green body comprising grains of super hard material and a binder, such as an organic binder. The green body may also comprise catalyst material for promoting the sintering of the super hard grains. The green body may be made by combining the grains with the binder and forming them into a body having substantially the same general shape as that of the intended sintered body, and drying the binder. At least some of the binder material may be removed by, for example, burning it off. The green body may be formed by a method including a compaction process, injection or other methods such as molding, extrusion, deposition modelling methods. The green body may be formed from components comprising the grains and a binder, the components being in the form of sheets, blocks or discs, for example, and the green body may itself be formed from green bodies.

One example of a method for making a green body includes providing tape cast sheets, each sheet comprising, for example, a plurality of diamond grains bonded together by a binder, such as a water-based organic binder, and stacking the sheets on top of one another and on top of a support body. Different sheets comprising diamond grains having different size distributions, diamond content or additives may be selectively stacked to achieve a desired structure. The sheets may be made by a method known in the art, such as extrusion or tape casting methods, wherein slurry comprising diamond grains and a binder material is laid onto a surface and allowed to dry. Other methods for making diamond-bearing sheets may also be used, such as described in U.S. Pat. Nos. 5,766,394 and 6,446,740. Alternative methods for depositing diamond-bearing layers include spraying methods, such as thermal spraying.

A green body for the super hard construction may be placed onto a substrate, such as a cemented carbide substrate to form a pre-sinter assembly, which may be encapsulated in a capsule for an ultra-high pressure furnace, as is known in the art. The substrate may provide a source of catalyst material for promoting the sintering of the super hard grains. In some examples, the super hard grains may be diamond grains and the substrate may be cobalt-cemented tungsten carbide, the cobalt in the substrate being a source of catalyst for sintering the diamond grains. The pre-sinter assembly may comprise an additional source of catalyst material.

In one version, the method may include loading the capsule comprising a pre-sinter assembly into a press and subjecting the green body to an ultra-high pressure and a temperature at which the super hard material is thermodynamically stable to sinter the super hard grains. In some examples, the green body comprises diamond grains and the pressure to which the assembly is subjected is at least about 5 GPa and the temperature is at least about 1,300 degrees centigrade.

A version of the method may include making a diamond composite structure by means of a method disclosed, for example, in PCT application publication number WO2009/128034 for making a super-hard enhanced hard-metal material. A powder blend comprising diamond particles, and a metal binder material, such as cobalt may be prepared by combining these particles and blending them together. An effective powder preparation technology may be used to blend the powders, such as wet or dry multi-directional mixing, planetary ball milling and high shear mixing with a homogenizer. In one example, the mean size of the diamond particles may be at least about 50 microns and they may be combined with other particles by mixing the powders or, in some cases, stirring the powders together by hand. In one version of the method, precursor materials suitable for subsequent conversion into binder material may be included in the powder blend, and in one version of the method, metal binder material may be introduced in a form suitable for infiltration into a green body. The powder blend may be deposited in a die or mold and compacted to form a green body, for example by uni-axial compaction or other compaction method, such as cold isostatic pressing (CIP). The green body may be subjected to a sintering process known in the art to form a sintered article. In one version, the method may include loading the capsule comprising a pre-sinter assembly into a press and subjecting the green body to an ultra-high pressure and a temperature at which the super hard material is thermodynamically stable to sinter the super hard grains.

After sintering, the polycrystalline super hard constructions may be ground to size and may include, if desired, a chamfer of, for example, approximately 0.4 mm height and an angle of 45° applied to the body of polycrystalline super hard material so produced.

The sintered article may be subjected to a subsequent treatment at a pressure and temperature at which diamond is thermally stable to convert some or all of the non-diamond carbon back into diamond and produce a diamond composite structure. An ultra-high pressure furnace well known in the art of diamond synthesis may be used and the pressure may be at least about 5.5 GPa and the temperature may be at least about 1,250 degrees centigrade for the second sintering process.

A further example of a super hard construction may be made by a method including providing a PCD structure and a precursor structure for a diamond composite structure, forming each structure into the respective complementary shapes, assembling the PCD structure and the diamond composite structure onto a cemented carbide substrate to form an unjoined assembly, and subjecting the unjoined assembly to a pressure of at least about 5.5 GPa and a temperature of at least about 1,250 degrees centigrade to form a PCD construction. The precursor structure may comprise carbide particles and diamond or non-diamond carbon material, such as graphite, and a binder material comprising a metal, such as cobalt. The precursor structure may be a green body formed by compacting a powder blend comprising particles of diamond or non-diamond carbon and particles of carbide material and compacting the powder blend.

The present disclosure may be further illustrated by the following examples which are not intended to be limiting.

The grains of super hard material, such as diamond grains or particles in the starting mixture prior to sintering may be, for example, bimodal, that is, the feed comprises a mixture of a coarse fraction of diamond grains and a fine fraction of diamond grains. In some examples, the coarse fraction may have, for example, an average particle/grain size ranging from about 10 to 60 microns. By “average particle or grain size” it is meant that the individual particles/grains have a range of sizes with the mean particle/grain size representing the “average”. The average particle/grain size of the fine fraction is less than the size of the coarse fraction, for example between around 1/10 to 6/10 of the size of the coarse fraction, and may, in some examples, range for example between about 0.1 to 20 microns.

In some examples, the weight ratio of the coarse diamond fraction to the fine diamond fraction ranges from about 50% to about 97% coarse diamond and the weight ratio of the fine diamond fraction may be from about 3% to about 50%. In other examples, the weight ratio of the coarse fraction to the fine fraction will range from about 70:30 to about 90:10.

In further examples, the weight ratio of the coarse fraction to the fine fraction may range for example from about 60:40 to about 80:20.

In some examples, the particle size distributions of the coarse and fine fractions do not overlap and in some examples the different size components of the compact are separated by an order of magnitude between the separate size fractions making up the multimodal distribution.

The examples consists of at least a wide bi-modal size distribution between the coarse and fine fractions of super hard material, but some examples may include three or even four or more size modes which may, for example, be separated in size by an order of magnitude, for example, a blend of particle sizes whose average particle size is 20 microns, 2 microns, 200 nm and 20 nm.

Sizing of diamond particles/grains into fine fraction, coarse fraction, or other sizes in between, may be through known processes such as jet-milling of larger diamond grains and the like.

In examples where the super hard material is polycrystalline diamond material, the diamond grains used to form the polycrystalline diamond material may be natural or synthetic.

In some examples, the binder catalyst/solvent may comprise cobalt or some other iron group elements, such as iron or nickel, or an alloy thereof. Carbides, nitrides, borides, and oxides of the metals of Groups IV-VI in the periodic table are other examples of non-diamond material that might be added to the sinter mix. In some examples, the binder/catalyst/sintering aid may be Co.

The cemented metal carbide substrate may be conventional in composition and, thus, may be include any of the Group IVB, VB, or VIB metals, which are pressed and sintered in the presence of a binder of cobalt, nickel or iron, or alloys thereof. In some examples, the metal carbide is tungsten carbide.

In some examples, both the bodies of, for example, diamond and carbide material plus sintering aid/binder/catalyst are applied as powders and sintered simultaneously in a single UHP/HT process. The mixture of diamond grains and mass of carbide are placed in an HP/HT reaction cell assembly and subjected to HP/HT processing. The HP/HT processing conditions selected are sufficient to effect intercrystalline bonding between adjacent grains of abrasive particles and, optionally, the joining of sintered particles to the cemented metal carbide support. In one example, the processing conditions generally involve the imposition for about 3 to 120 minutes of a temperature of at least about 1200 degrees C. and an ultra-high pressure of greater than about 5 GPa.

In another example, the substrate may be pre-sintered in a separate process before being bonded together in the HP/HT press during sintering of the super hard polycrystalline material.

In a further example, both the substrate and a body of polycrystalline super hard material are pre-formed. For example, the bimodal feed of super hard grains/particles with optional carbonate binder-catalyst also in powdered form are mixed together, and the mixture is packed into an appropriately shaped canister and is then subjected to extremely high pressure and temperature in a press. Typically, the pressure is at least 5 GPa and the temperature is at least around 1200 degrees C. The preformed body of polycrystalline super hard material is then placed in the appropriate position on the upper surface of the preform carbide substrate (incorporating a binder catalyst), and the assembly is located in a suitably shaped canister. The assembly is then subjected to high temperature and pressure in a press, the order of temperature and pressure being again, at least around 1200 degrees C. and 5 GPa respectively. During this process the solvent/catalyst migrates from the substrate into the body of super hard material and acts as a binder-catalyst to effect intergrowth in the layer and also serves to bond the layer of polycrystalline super hard material to the substrate. The sintering process also serves to bond the body of super hard polycrystalline material to the substrate.

An example of a super hard construction may be made by a method including providing a cemented carbide substrate, contacting an aggregated, substantially unbonded mass of diamond particles against a surface of the substrate to form an pre-sinter assembly, encapsulating the pre-sinter assembly in a capsule for an ultra-high pressure furnace and subjecting the pre-sinter assembly to a pressure of at least about 5.5 GPa and a temperature of at least about 1,250 degrees centigrade, and sintering the diamond particles to form a PCD composite compact element comprising a PCD structure integrally formed on and joined to the cemented carbide substrate. In some examples of the invention, the pre-sinter assembly may be subjected to a pressure of at least about 6 GPa, at least about 6.5 GPa, at least about 7 GPa or even at least about 7.5 GPa.

Solvent/catalyst for diamond may be introduced into the aggregated mass of diamond grains by various methods, including blending solvent/catalyst material in powder form with the diamond grains, depositing solvent/catalyst material onto surfaces of the diamond grains, or infiltrating solvent/catalyst material into the aggregated mass from a source of the material other than the substrate, either prior to the sintering step or as part of the sintering step. Methods of depositing solvent/catalyst for diamond, such as cobalt, onto surfaces of diamond grains are well known in the art, and include chemical vapour deposition (CVD), physical vapour deposition (PVD), sputter coating, electrochemical methods, electroless coating methods and atomic layer deposition (ALD). It will be appreciated that the advantages and disadvantages of each depend on the nature of the sintering aid material and coating structure to be deposited, and on characteristics of the grain.

In one example of a method of the invention, cobalt may be deposited onto surfaces of the diamond grains by first depositing a pre-cursor material and then converting the precursor material to a material that comprises elemental metallic cobalt. For example, in the first step cobalt carbonate may be deposited on the diamond grain surfaces using the following reaction:

Co(NO₃)₂+Na₂CO₃->CoCO₃+2NaNO₃

The deposition of the carbonate or other precursor for cobalt or other solvent/catalyst for diamond may be achieved by means of a method described in PCT patent publication number WO/2006/032982. The cobalt carbonate may then be converted into cobalt and water, for example, by means of pyrolysis reactions such as the following:

CoCO₃->CoO+CO₂

CoO+H₂->Co+H₂O

In another example, cobalt powder or precursor to cobalt, such as cobalt carbonate, may be blended with the diamond grains. Where a precursor to a solvent/catalyst such as cobalt is used, it may be necessary to heat treat the material in order to effect a reaction to produce the solvent/catalyst material in elemental form before sintering the aggregated mass.

In some examples, the cemented carbide substrate may be formed of tungsten carbide particles bonded together by the binder material, the binder material comprising an alloy of Co, Ni and Cr. The tungsten carbide particles may form at least 70 weight percent and at most 95 weight percent of the substrate.

Generally, the body of polycrystalline diamond material will be produced and bonded to the cemented carbide substrate in a HPHT process.

The sintered construction is then subjected to a post-synthesis treatment to assist in improving thermal stability of the sintered structure, by removing catalysing material from a region of the polycrystalline layer adjacent an exposed surface thereof, namely the working surface opposite the substrate. It has been found that the removal of non-binder phase from within the PCD table, conventionally referred to as leaching, is desirable in various applications. The residual presence of solvent/catalyst material in the microstructural interstices is believed to have a detrimental effect on the performance of PCD compacts at high temperatures as it is believed that the presence of the solvent/catalyst in the diamond table reduces the thermal stability of the diamond table at these elevated temperatures. Therefore leaching is desired to enhance thermal stability of the PCD body. However, leaching solvent/catalyst material from a PCD structure is known to reduce its fracture toughness and strength by between 20 to 30%.

The present applicants have surprisingly determined that, contrary to conventional expectations, the distance 56 from the midpoint of the chamfer 40 to the leached/unleached boundary along a plane substantially perpendicular to the plane in which the chamfer lies should be at least X divided by two, where X is 0.8 times the thickness of the diamond table. In some examples, the distance “0.8 X” which is denoted by the reference numeral 42 in FIG. 3 may correspond to the radial distance along the working surface 34 from the notional edge of the construction (had the construction remained cylindrical without application of the chamfer) to the point on the working surface denoting the leached region/unleached boundary. In some examples, this distance 42 is substantially equal to the distance along the barrel 54 from the (unchamfered) edge 46 of the construction to the point on the barrel surface 54 denoting the leached region/unleached boundary. Additionally, the applicants have found it may be advantageous in some examples, for the leach depth at a radial distance of 1 mm from the notional peripheral side edge 46 of the working face of the construction (had the chamfer not been applied to the construction) to be at least 600 microns, and in some examples at least 700 microns.

It has been appreciated by the applicant that, surprisingly, the above may assist in controlling spalling events during use of the PCD construction in applications by assisting in managing the thermal wear events of the construction thereby potentially delaying the onset of spalling and prolonging the working life of the construction 30.

Removal of the catalysing material may be carried out using methods known in the art such as electrolytic etching, acid leaching or evaporation techniques. However, the leaching profiles of the examples described above and shown in FIG. 3 may be obtained by, for example, the additional steps set out below.

In some examples, a protective layer, or mask is applied to the body of PCD material that extends either up to the working surface 34 and down the chamfer surface 40 and may also extend down the barrel 54 depending on the leaching technique to be applied and the fixtures holding the construction during the leaching process. The protective layer or mask is designed to prevent the leaching solution from chemically damaging certain portions of the body of PCD material and/or the substrate 36 attached thereto during leaching and the positioning of the mask or layer close to or at the working surface 36 has been determined to effect the leaching profile shown in FIG. 3 as it enables selective leaching of the body of PCD material, which may be beneficial. Following leaching, the protective layer or mask may be removed.

The interstitial material which may include, for example, the metal-solvent/catalyst and one or more additions in the form of carbide additions, may be leached from the interstices in the body of PCD material by exposing the PCD material to a suitable leaching solution.

Control of the where the PCD element is leached may be important for a number of reasons. Firstly, it may be desirable not to remove the catalyst from all areas of the PCD, such as regions that are not exposed to such extreme heat or that may benefit from the mechanical strength conferred by the catalyst. Secondly, the substrate is typically made of a material such as tungsten carbide whose resistance to harsh leaching conditions is far less than that of the diamond matrix. Accordingly, exposure of the substrate to the leaching mixture may cause serious damage to the substrate, often rendering the PCD element as a whole useless. Thirdly, the presence of the catalyst in the PCD near the substrate may be useful to assist in strengthening the region of the interface between the substrate and the PCD so that the PCD body does not separate from the substrate during use of the element. It may therefore be important to protect the interface region from the leaching mixture.

Various systems for protecting non-leached portions of a PCD element and providing a mask are known to include, for example, encasing the PCD element in a protective material and removing the masking material from the regions to be leached, or coating the portion of the element to not be leached with a masking material.

Leaching may take place over a time span of a few hours to a few months. In particular examples, it may take less than one day (24 hours), less than 50 hours, or less than one week. Leaching may be performed at room temperature or at a lower temperature, or at an elevated temperature, such as the boiling temperature of the leaching mixture.

The duration and conditions of the leaching treatment process may be determined by a variety of factors including, but not limited to, the leaching agent used, the depth to which the PCD construction is to be leached, and the percentage of catalyst to be removed from the leached portion of the PCD construction.

In some examples, the leaching process may also be conducted at an elevated pressure.

Additionally, in some examples, at least a portion of the body of PCD material and the leaching solution may be exposed to at least one of an electric current, microwave radiation, and/or ultrasonic energy to increase the rate at which the body of PCD material 20 is leached.

Thus, chemical leaching may be used to remove the metal-solvent catalyst and any additions from the body of super hard material 20 either up to a desired depth from an external surface of the body of PCD material or from substantially all of the super hard material 30 whilst maintaining the leaching profile shown in FIG. 3. Following leaching, the body of super hard material 30 may therefore comprise a first volume that is substantially free of a metal-solvent catalyst. However, small amounts of catalyst may remain within interstices that are inaccessible to the leaching process. Additionally, following leaching, the body of super hard material 30 may also comprise a volume that contains a metal-solvent catalyst. In some examples, this further volume may be remote from one or more exposed surfaces of the body of super hard material 30.

It is to be understood that the exact depth of the thermally stable region can be selected to and will vary depending on the desired particular end use drilling and or cutting applications.

Once leached to the desired profile, the PCD construction may optionally be washed, cleaned, or otherwise treated to remove or neutralize residual leaching agent.

HF-HNO3 may be an effective media for the removal of tungsten carbide (WC) from a sintered PCD table. Alternatively, HCl and other similar mineral acids are easier to work with at high temperatures than HF-HNO3 and are aggressive towards the catalyst/solvent, particularly cobalt (Co). HCl, for example, may remove the bulk of the catalyst/solvent from the PCD table in a reasonable time period, depending on the temperature, typically in the region of 80 hours.

According to some examples, the leaching solution may comprise one or more mineral acids and diluted nitric acid. The body of PCD material may be exposed to such a leaching solution in any suitable manner, including, for example, by immersing at least a portion of the body of PCD material 30 in the leaching solution for a period of time.

Examples of suitable mineral acids may include, for example, hydrochloric acid, phosphoric acid, sulphuric acid, hydrofluoric acid, and/or any combination of the foregoing mineral acids.

The polycrystalline super hard layer 20 to be leached by examples of the method may, but not exclusively, have a thickness of about 1.5 mm to about 3.5 mm.

After leaching, leached depths of the PCD table may be determined for various portions of the PCD table, through conventional x-ray analysis. Furthermore, the profile of boundary between the leached and unleached regions in the PCD construction 30 may be determined by a number of techniques including non-destructive x-ray analysis wherein the cutter is x-rayed after leaching, SEM imaging techniques wherein a polished section of the construction is obtained by means of a wire EDM. The cross section may be polished in preparation for viewing by a microscope, such as a scanning electron microscope (SEM) and a series of micrographic images may be taken. Each of the images may be analysed by means of image analysis software to determine the profile of the cross-section.

The construction may be processed by grinding and polishing as a post-synthesis treatment to provide an insert for a rock-boring drill bit.

In order to test the wear resistance of the sintered polycrystalline products formed according to the above methods, PCD constructions were produced and leached having the leaching profile of FIG. 3. A further control cutter was formed having the same composition as the PCD construction but having a leaching profile having a substantially uniform leach depth extending across the diameter of the construction rather than the tapered leaching profile of FIG. 3 for comparison. The diamond layers were then polished and a subjected to a vertical boring mill test. In this test, the wear flat area was measured as a function of the number of passes of the cutter element boring into the workpiece. The results provide an indication of the total wear scar area plotted against cutting length.

It will be seen that the PCD compacts formed according to an example having the leaching profile of FIG. 3 were able to achieve a significantly greater cutting length and smaller wear scar area than the control cutter.

Whilst not wishing to be bound by a particular theory, using the conditions described herein it was determined possible to achieve a mechanically stronger and more wear-resistant body of PCD material which, when used as a cutter, may significantly enhance the durability of the cutter produced according to some examples described herein.

The preceding description has been provided to enable others skilled the art to best utilize various aspects of the examples described by way of example herein. This description is not intended to be exhaustive or to be limited to any precise form disclosed. Many modifications and variations are possible. In particular, the method described is equally applicable to the effective leaching of PCD with other acid combinations such as mineral acids and/or complexing agents.

1. A polycrystalline super hard construction comprising a body of polycrystalline diamond (PCD) material comprising a plurality of interstitial regions between inter-bonded diamond grains forming the polycrystalline diamond material; the body of PCD material comprising:
a working surface positioned along an outside portion of the body;
a first region substantially free of a solvent/catalysing material; the first region extending a depth from the working surface into the body of PCD material along a plane substantially perpendicular to the plane along which the working surface extends; and
a second region remote from the working surface that includes solvent/catalysing material in a plurality of the interstitial regions; the first region joining the second region along a boundary therebetween;
a substrate attached to the body of PCD material along an interface with the second region;
a chamfer extending between the working surface and a peripheral side surface of the body of PCD material and defining a cutting edge at the intersection of the chamfer and the peripheral side surface; the body of PCD material having a thickness along the peripheral side surface from the working surface to the substrate; wherein:
the distance from the midpoint of the chamfer to the boundary of the first and second regions along a plane substantially perpendicular to the plane in which the chamfer extends is at least X divided by two, where X is 0.8 times the thickness of the body of PCD material.

2. The polycrystalline super hard construction of claim 1, wherein the depth from the working surface of the boundary between the first and second regions at a radial distance of 1 mm from the cutting edge is at least 600 microns.

3. The polycrystalline super hard construction of claim 1, wherein the depth from the working surface of the boundary between the first and second regions at a radial distance of 1 mm from the cutting edge is at least 700 microns.

4. The polycrystalline super hard construction of claim 1, wherein the depth from the working surface of the boundary between the first and second regions at a radial distance of 1 mm from the cutting edge is between around 600 microns to around 1800 microns.

5. The polycrystalline super hard construction of claim 1, wherein the depth from the working surface of the boundary between the first and second regions at a radial distance of 1 mm from the cutting edge is between around 700 microns to around 1800 microns.

6. The polycrystalline super hard construction of claim 1, wherein the first region intersects the peripheral side surface at a position at least around 1000 microns from the cutting edge.

7. The polycrystalline super hard construction of claim 1, wherein the first region intersects the peripheral side surface at a position between around 50 to 700 microns from the cutting edge.

8. The polycrystalline super hard construction according to claim 1, wherein the solvent/catalyst in the second region comprises cobalt, and/or one or more other iron group elements, such as iron or nickel, or an alloy thereof, and/or one or more carbides, nitrides, borides, and oxides of the metals of Groups IV-VI in the periodic table.

9. A polycrystalline super hard construction according to claim 1, wherein the body of polycrystalline diamond material has a thickness of around 2.5 mm to around 3.5 mm or greater.

10. A cutter for boring into the earth comprising the polycrystalline super hard construction according to claim 1.

11. A PCD element for a rotary shear bit for boring into the earth, for a percussion drill bit or for a pick for mining or asphalt degradation, comprising the polycrystalline super hard construction of claim 1.

12. A drill bit or a component of a drill bit for boring into the earth, comprising a polycrystalline super hard construction according to claim 1.

13. A method for making a thermally stable polycrystalline diamond (PCD) construction comprising the steps of:
machining a polycrystalline diamond (PCD) body attached to a substrate along an interface, the polycrystalline diamond body comprising a plurality of interbonded diamond grains and interstitial regions disposed therebetween, to form a chamfer extending between a working surface positioned along an outside portion of the body and a peripheral side surface of the body;
treating the PCD body to remove a solvent/catalyst material from a first region of the diamond body while allowing the solvent/catalyst material to remain in a second region of the diamond body;
the chamfer defining a cutting edge at the intersection of the chamfer and the peripheral side surface; wherein:
the step of treating further comprises masking the PCD body at a position between 0 microns to around 300 microns from the working surface; and
the step of removing solvent/catalyst from the interstitial regions in the first region comprises removing the solvent/catalyst such that the distance from the midpoint of the chamfer to the boundary of the first and second regions along a plane substantially perpendicular to the plane in which the chamfer extends is at least X divided by two, where X is 0.8 times the thickness of the body of PCD material.

14. The method of claim 13, wherein the step of treating comprises treating the PCD body to form a depth from the working surface of the boundary between the first and second regions at a radial distance of 1 mm from the cutting edge of at least 600 microns.

15. The method of claim 13, wherein the step of treating comprises treating the PCD body such that the depth from the working surface of the boundary between the first and second regions at a radial distance of 1 mm from the cutting edge is between around 600 microns to around 1800 microns.

16. The method of claim 13, wherein the step of removing solvent/catalyst from the interstitial regions in the first region comprises removing the solvent/catalyst to a depth in the first region such the first region intersects the peripheral side surface at a position at least around 1000 microns from the cutting edge.

17. The method of claim 13, wherein the step of removing solvent/catalyst from the interstitial regions in the first region comprises removing the solvent/catalyst to a depth in the first region such the first region intersects the peripheral side surface at a position between around 50 to 1000 microns from the cutting edge.

18. The method of claim 13, wherein prior to the step of treating, forming the PCD construction, the step of forming comprising:
providing a mass of diamond grains;
arranging the mass of diamond grains to form a pre-sinter assembly; and
treating the pre-sinter assembly in the presence of catalyst/solvent material for the diamond grains at an ultra-high pressure of around 5.5 GPa or greater and a temperature at which the diamond material is more thermodynamically stable than graphite to sinter together the grains of diamond material to form a polycrystalline diamond construction.

19. The method of claim 13, wherein prior to the step of treating, the method further comprising machining the polycrystalline diamond body to a final dimension.

20. The method of claim 13, wherein after the step of treating, the method further comprising machining the polycrystalline diamond body to a final dimension.
